(19) United States
(12) Patent Application Publication
(10) Pub. No.: US 2020/0357000 A1
(43) Pub. Date: Nov. 12, 2020

(54) SYSTEM AND METHOD FOR AUTOMATED REGULATORY COMPLIANCE DECISION MAKING ASSISTANCE

(71) Applicant: Xerox Corporation, Norwalk, CT (US)

(72) Inventors: Jonathan D. Levine, Rochester, NY (US); Michael Patrick Wiseman, Webster, NY (US); Ray Uri Merriam, Rochester, NY (US); Stephen K. Korndoerfer, West Henrietta, NY (US); Vijayakrishna Nama, Hyderabad (IN); Larry R. Glass, Pittsford, NY (US)

(73) Assignee: Xerox Corporation, Norwalk, CT (US)

(21) Appl. No.: 16/406,383

(22) Filed: May 8, 2019

(51) Int. Cl. G06Q 30/00; G06N 5/04; G06Q 10/10

(52) U.S. Cl. CPC G06Q 30/018; G06N 20/00; G06Q 10/10; G06N 5/045

(57) ABSTRACT

A method and system provide for automatically evaluating a request for regulatory compliance approval. The method makes use of historical data that includes information extracted from prior requests for regulatory compliance approval that have previously been submitted by multiple requesting organizations and information extracted from prior responses to the prior requests, provided by at least one regulatory body. A prediction model may have been trained on the historical data. A new request for regulatory compliance approval or new data for generating the new request is received from a requesting organization. New information is extracted from the new request or from the new data for generating the new request. Based on the extracted new information and the historical data (e.g., using the prediction model), a proposal for a response to the new request is generated. Access to the proposal is provided to a regulatory body reviewing the new request.

### BACKGROUND

The present application relates to regulatory compliance and finds particular application in connection with a system and method which uses historical data to predict a regulator's decision for a regulatory request.

Companies and other organizations often need to seek regulatory approval or meet reporting requirements for goods they plan to market, chemicals they use, test, or dispose of, or processes employed in manufacturing, treatment, or testing, and the like. The global regulatory environment is becoming more complex. Stricter regulations may mean a company has to repeat the approval process after internal review and possible modifications. Additionally, regulations may vary between nations, states, and municipalities, entailing making multiple applications. For example, as restricted chemicals that leak into the environment are identified as causing potential health and environmental hazards, regulatory agencies may impose more comprehensive requirements for chemical compliance. There are many other areas where compliance is evaluated such as school district compliance with requirements for student achievement.

While the compliance process can be time-consuming for organizations seeking approval, the regulatory bodies themselves are often not prepared to handle the quantity of data that the new regulations generate. In many agencies, the decision-making process still is highly manual and often paper-based. Therefore, the new regulations may have the unintended result of slowing, and increasing the cost of, the regulatory approval process, both for regulatory agencies and those seeking approval.

It has been suggested that there should be a mechanism for companies requesting regulatory approval to be able to check their submissions for compliance and be provided with help in addressing any non-compliance issues. However, different regulatory personnel, with differences in their training, backgrounds, culture, and viewpoints, may view similar requests for regulatory approval differently, resulting in some being granted while others are rejected. Thus, providing such guidance may be difficult.

There remains a need for a system and method for assisting reviewers in making decisions about whether an organization has met the agency's requirements for approval of a request, which may speed up the decision-making process and result in more uniform decisions between reviewers.

### INCORPORATION BY REFERENCE

The following references, the disclosures of which are incorporated herein in their entireties by reference, are mentioned:

US Pub. No. 20140222655A1, published Aug. 7, 2014, entitled METHOD AND SYSTEM FOR AUTOMATIC REGULATORY COMPLIANCE, by Cummings, describes a system and method for implementing an automated database-driven web interface for ensuring compliance with various laws relating to financial transactions.

U.S. Pub. No. 20190079913, published Mar. 14, 2019, entitled REGULATORY COMPLIANCE SYSTEM, by Levine, et al., describes a method and system for regulatory compliance which aggregates a set of report forms in a repository. In response to a request for the compliance data of a product that is going to market, the system matches the product to the relevant form(s) in the repository. A separate report is generated for each agency involved in the decision-making.

U.S. application Ser. No. 16/179,051, filed Nov. 2, 2018, entitled METHOD AND SYSTEM FOR PREDICTING THE PROBABILITY OF REGULATORY COMPLIANCE APPROVAL, by Levine, et al., describes methods and systems for providing requestors with a prediction of the probability of regulatory compliance approval, based on data collected from reviewers, and also what is missing for a regulatory approval application.

### BRIEF DESCRIPTION

In accordance with one aspect of the exemplary embodiment, a method for evaluating a request for regulatory compliance approval is provided. The method includes providing historical data, the historical data including information extracted from prior requests for regulatory compliance approval from multiple requesting organizations and information extracted from responses to the prior requests generated by a regulatory body. A new request for regulatory compliance approval, or new data for generating the new request, is received from a requesting organization. New information is extracted from the new request or from the new data. A proposal for a response to the new request is generated, based on the new information and historical data. Access to the proposal is provided to the regulatory body to which the new request is submitted for review.

One or more steps of the method may be performed with a processor.

In accordance with another aspect of the exemplary embodiment, a system for evaluating a request for regulatory compliance approval includes an interface which receives a new request for regulatory compliance approval to a particular regulatory body, or new data for generating the new request, from a requesting organization. The system further includes a prediction model, which has been trained, based on historical data, to output a prediction for a new request for regulatory compliance approval. The historical data includes information extracted from prior requests for regulatory compliance approval from multiple requesting organizations and information extracted from responses to the prior requests generated by at least one regulatory body. A proposal generator inputs information extracted from at least one of the new request and the new data into the trained prediction model and generates a proposal, including a proposed decision for the new request, based on an output of the prediction model. A submission component provides access to the proposal to a regulatory body reviewing the new request. A prediction model generation component receives a response to the new request, generated by the regulatory body, and updates the prediction model, based on the new request, proposal, and response. A processor implements the proposal generator, submission component, and update component.

In accordance with another aspect of the exemplary embodiment, a method for generating a system for evaluating a request for regulatory compliance approval includes collecting historical data, the historical data comprising information extracted from prior requests for regulatory compliance approval from multiple requesting organizations and information extracted from responses to the prior requests generated by at least one regulatory body, training a prediction model to output a prediction for a new request for regulatory compliance approval, the training being based on the historical data, providing an interface for receiving a new request for regulatory compliance approval or new data for generating the new request from a requesting organization, providing an extraction component for extracting information from the new request or from the new data, providing a proposal generator with access to the trained prediction model, the proposal generator generating a proposal for the new request, based on the extracted information and a prediction output by the trained prediction model, providing a submission component which provides a regulatory body that reviews the new request with access to the proposal for the new request, providing a reception component which receives a response, generated by the regulatory body, and providing for updating the trained prediction model, based on the received response.

One or more steps of the method may be performed with a processor.

### BRIEF DESCRIPTION OF THE DRAWINGS

FIG. 1 is a functional block diagram of an environment in which a regulatory compliance system operates in accordance with one aspect of the exemplary embodiment;

FIG. 2 illustrates types of requestors and involved reviewers interacting with the regulatory compliance system of FIG. 1;

FIG. 3 is a functional block diagram of an embodiment of the regulatory compliance system of FIG. 1;

FIG. 4 illustrates a proposal for responding to a regulatory compliance request;

FIG. 5 illustrates a filled template for responding to a regulatory compliance request;

FIG. 6 is a flow chart illustrating a method for evaluation of a regulatory compliance request; and

FIG. 7 is a flow chart illustrating a method for generating a system for evaluation of a regulatory compliance request.

### DETAILED DESCRIPTION

Aspects of the exemplary embodiment provide a system and method for assisting regulatory agencies in providing decisions on requests for regulatory approval. A regulatory compliance system (RCS) serves as a digital assistant for public-sector reviewers by using historical data to predict the decision for a current request. The RCS generates a proposed decision (e.g., approved, denied, or incomplete) on a request for regulatory approval and provides a rationale for the proposal. The proposal may be reviewed by a reviewer, who can confirm or modify the proposed decision. The agency decision is fed back into the RCS system and is used to improve the digital assistant's future decision-making.

As used herein, a “requestor” may be any person or persons seeking approval of a regulatory compliance request submitted to a regulatory body. A requestor may be, for example, an employee of a company or other organization on behalf of which the request is being submitted, or an employee of an outside company or organization tasked with preparing requests on behalf of the requesting company.

A “reviewer,” as used herein may be any person or persons authorized by the regulatory body, to make decisions on requests for regulatory compliance approval that are submitted to the regulatory body. For example, a reviewer may be a regulatory body employee, outside contractor authorized to act on behalf of the regulatory body, or the like.

A “regulatory body” may be any public or private body charged with ensuring compliance with regulations, such as a regulatory agency charged with implementing government regulations when evaluating regulatory compliance requests submitted to the agency for approval, or a private organization implementing regulations laid down by the organization for evaluating regulatory compliance requests submitted to the organization for approval.

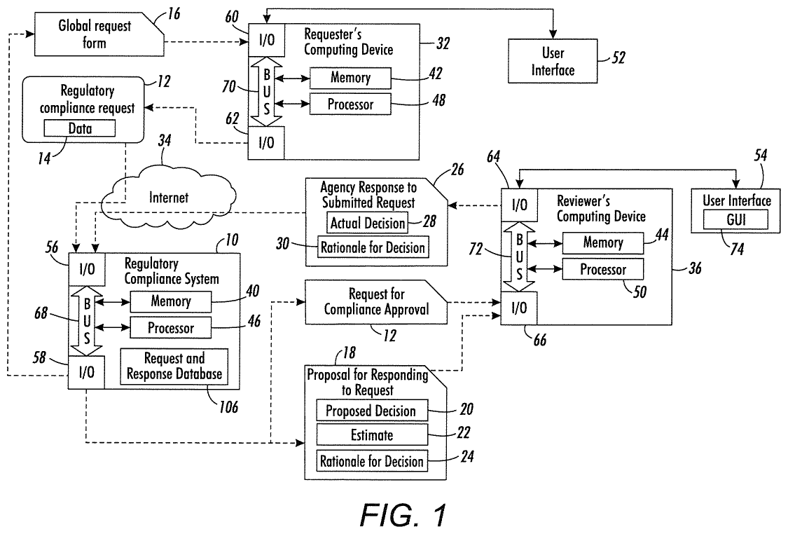

FIG. 1 illustrates an environment in which such a regulatory compliance system 10 operates. The system 10 receives, as input, a regulatory compliance request 12 and/or data 14 to be used in formulating a request 12 to be submitted to a regulatory agency. In one embodiment, each regulatory agency from each supported nation, region, state, and/or municipality supplies its latest forms to the system 10, and the system obtains the appropriate data 14 from the requestor for filling fields of the relevant forms to be submitted to each agency. In one embodiment, the system provides a global request form 16 to the requestor. The requestor supplies data 14 for the fields of the global request form 16, which is used to generate regulatory compliance requests 12 for different regulatory agencies, e.g., in different countries.

The requestor may be a private company seeking the regulatory approval for goods to be sold, services to be provided, chemicals used in manufacture, testing, treatment, or to be disposed of, or processes employed in manufacturing, treatment, or testing, or the like. Alternatively, the requestor may be an organization acting on the company's behalf. In another embodiment, the requestor may be a government agency. The system 10 outputs a proposal 18 for the submitted request 12, which may include some or all of: a proposed overall decision 20 for the request (e.g., for approval, denial of the submitted request 12, or to hold for more information); an estimate 22 (e.g., a confidence probability) that the proposed decision is correct; proposed sub-decisions for the request 12 (e.g., for approval, denial of components of the overall decision, or hold for more information) and respective estimates; and a proposed rationale 24 for the proposed decision. The proposed rationale 24 provides one or more reasons as to why the request should be granted, denied held, or otherwise addressed, thereby speeding up the regulatory decision-making process and lowering agency costs. The proposed rationale may be based on the predictions for the individual components of the overall decision and other factors.

The submitted request 12 and decision proposal 18 are provided to a reviewer responsible for making an actual decision on the submitted request. An agency response 26 to the submitted request, generated by a human reviewer, may include the agency decision 28 and optionally a rationale 30 for the decision.

For example, as illustrated in FIG. 1, the request 12 or data 14 therefor is generated by the requestor on a requestor's computing device 32, which is communicatively connected to the regulatory compliance system 10 by wired or wireless links 34, such as the Internet. The regulatory compliance system 10 is communicatively connected to a reviewer's computing device 36 by wired or wireless links, such as an intranet or the Internet.

Each of the computing devices 10, 32, 36 includes respective memory 40, 42, 44, storing instructions and relevant data for performing operations applicable to the respective device, and a processor device 46, 48, 50, in communication with the memory, for executing the instructions. The requestor's and regulator's computing devices may each include or be associated with a user interface device 52, 54, for displaying information to users and receiving inputs from users, and may include one or more of a display device, touchscreen, writable screen, keyboard, keypad, cursor control device, and the like. One or more input/output (I/O) devices 56, 58, 60, 62, 64, 66 allow the computing devices to communicate with external devices, e.g., via wired or wireless connections, such as the Internet. Hardware components 40, 42, 44, 46, 48, 50, 56, 58, 60, 62, 64, 66 of the respective computing devices 10, 32, 36 may communicate via a respective data/control bus 68, 70, 72.

Using the user interface device 54, a human reviewer can review a request 12 and its accompanying proposal 18, which have been received by the agency from the regulatory compliance system 10. The proposal 18 may be presented to the human reviewer via a graphical user interface (GUI) 74 displayed on the user interface device 54. The user interface device 54 can also be used by the reviewer to generate an appropriate response 26, which may be based, at least in part, on the proposal 18, if the reviewer determines that the proposal should be adopted by the agency. The GUI 74 may be configured to generate the response 26 automatically, if the reviewer indicates that the proposal should be adopted, and/or to permit the reviewer to make modifications to an automatically-generated draft response.

In the described environment, each memory 40, 42, 44 may represent any type of non-transitory computer readable medium such as random-access memory (RAM), read only memory (ROM), magnetic disk or tape, optical disk, flash memory, or holographic memory. In one embodiment, each memory comprises a combination of random-access memory and read only memory. Memory 40 stores instructions for performing at least part of the exemplary method as well as the processed data.

The input/output interfaces 56, 58, 60, 62, 64, 66 of the computing devices 10, 32, 36 allow each computer to communicate with other devices via a computer network, such as a local area network (LAN) or wide area network (WAN), or the internet, and may comprise a modulator/demodulator (MODEM) a router, a cable, and/or Ethernet port.

The digital processor devices 46, 48, 50 can be variously embodied, such as by a single-core processor, a dual-core processor (or more generally by a multiple-core processor), a digital processor and cooperating math coprocessor, a digital controller, or the like. Each digital processor, in addition to executing instructions for performing a part of the method, may also control the operation of the respective computer.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or the like, and is also intended to encompass so-called “firmware” that is software stored on a ROM or the like. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

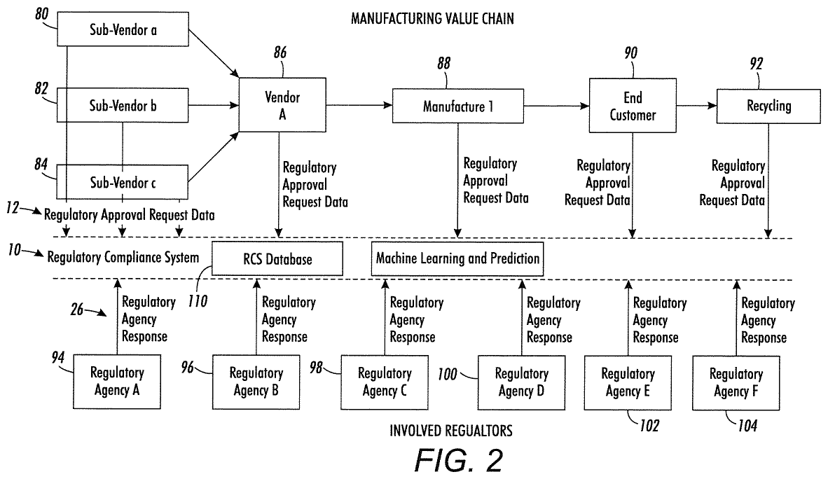

As will be appreciated, while a single requestor's computing device 32 and a single reviewer's computing device 36 are illustrated in FIG. 1, in practice, there are at least two or at least ten of each type of device in communication with the regulatory compliance system 10. For example, as illustrated in FIG. 2, various requestors in a manufacturing value chain, such as sub-vendors 80, 82, 84, vendors 86, manufacturers 88, customers 90, and recyclers 92 of the vendors/manufacturer's products, and multiples thereof, may each generate respective regulatory approval requests 12 for submission to one or more of a set of two or more regulatory agencies 94, 96, 98, 100, 102, 104, each with its own set of reviewers operating respective computing devices 36. For example, various sub-vendors 80, 82, 84 may require regulatory approval from one or more of the regulatory agencies 94, 96, 98, 100, 102, 104 prior to providing a product or service to a vendor 86, and so forth along the value chain.

The reviewers may be operating at any level, e.g., national, regional, state, or municipal. The regulatory agencies may each generate responses 26 to the submitted requests 12. The requests 12 and responses 26 are all passed through the regulatory compliance system 10, where they are stored in a database table (or other suitable data structure) 106 (FIG. 1) The system 10 includes components for analysis of the data and prediction of a decision, as described in further detail below. In this way, the system has access to prior requests 12 and prior agency responses 26 for multiple organizations and multiple regulatory agencies and reviewers and is able to make recommendations 18 for new requests 12, based on this aggregated data.

Each submitting organization 80, 82, 84, 86, 88, 90, 92, etc., may be expected to provide confidential data 14 to the system 10, i.e., data that is not intended to be shared with other organizations. Even the fact that a request 12 is being submitted by an organization may be considered confidential. To maintain the privacy of the respective organizations, the system 10 does not share each organization's confidential data 14, and requests 12 generated therefrom, with other request submitting organizations, unless authorized to do so. The system 10 generally provides the proposal 18 only to the regulatory body and/or those authorized by the regulatory body to review it. Thus, the proposal 18 that is provided to the regulatory body (or sensitive parts thereof), in particular, the rationale 24, is/are not shared with the respective requestor and requesting organization (and is not shared with other request-submitting organizations), particularly if it violates the privacy of other organizations by sharing their confidential data. However, parts of the proposal 18 may be subsequently incorporated into an agency response 26, which in some cases, may be made public.

The system 10 acts as a digital assistant for reviewers who have to decide whether to approve or deny requests 12 for regulatory approval. The system 10 improves the accuracy and correctness of its proposals 18 over time. As the system 10 improves and tracks the accuracy of its proposed decisions 20 and accompanying rationales 24, reviewers may be able to delegate more of the decision-making to the system 10, thereby mitigating the problem of increased volume of regulatory approval requests over time. In some cases, reviewers may delegate the entire decision-making process to the system 10, e.g., when certain predefined criteria are met.

For a particular request to a particular regulator or regulatory body, the system can describe what information is missing from rejected requests. Further, reviewers can use the system 10 to determine what information is most frequently missing from requests and can communicate this to the private sector requestors so that more initial requests are approved.

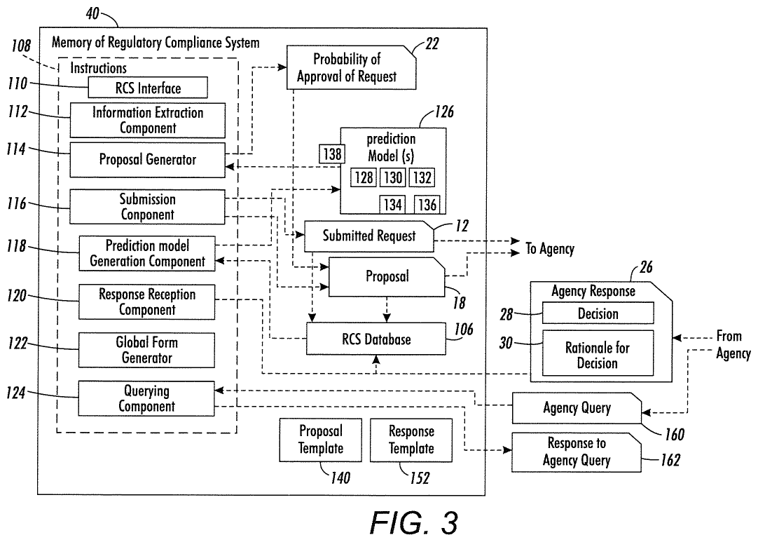

With reference now to FIG. 3, the memory 30 of the regulatory compliance system 10 stores instructions 108 for performing the various functions described herein. The illustrated instructions 108 include an RCS interface 110, a database generation component 112, a proposal generator 114, a submission component 116, a response reception component 118, a prediction model generation component 120, a global form generator 122, and a querying component 124. It is to be appreciated that the system may include fewer, more, or different components.

Briefly, the RCS interface 110 communicates with requestors in generating a request 12 to be submitted to a regulatory agency for approval, on behalf of a company, and for providing requestors with agency responses 26 to their requests. The RCS interface 110 may generate a request 12 based on the request data 14 received from a requestor's computing device 32. The RCS interface 110 may perform similarly to the system described in above-mentioned U.S. Ser. No. 16/179,051, incorporated herein by reference. In other embodiments, the requestor may generate the request 12, including some or all of the data 14, which is received by the RCS interface 110.

The data 14 supplied by the requestor may include information to which the requestor company has access which is relevant to the subject of the request, such as some or all of: the target regulatory agency, the submitting company name, the compliance type (e.g., chemical composition or process, e.g., when evaluating a request for incorporating a restricted chemical in a manufactured product), the industry type (e.g., chemical), the field of use of a product that is the subject of the request (e.g., aquatic or land-based environment), the chemical composition of a product that is the subject of the request (e.g., concentrations of hazardous chemicals), test data for the subject of the request, links to publications discussing the subject of the request, and prior responses that the company has received from the respective agency for other requests with different combinations of such factors. It is assumed that the company does not have access to responses to requests that were submitted by other companies, or at least has only limited access.

The request 12 may include a set of fields for entering parts of the data 14, such as that described above. Some fields may permit the insertion of free text (e.g., a field in which a requestor's description of a composition for which approval is sought may be inserted). Other fields may limit the requestor's input to a selected one of a set of predefined options (e.g., a selection of a target regulatory agency from a predefined set of regulatory agencies, or an industry type from a predefined set of industry types). Some of the data 14 in the request 12 may be in the form of attachments, such as relevant company documents or links to public documents.

The regulatory agency may specify the types of information that are required and/or permitted to be included in a request 12. The types of information may vary from agency to agency and depending on the type of approval being sought. For example, in the case of a printer manufacturer seeking approval for a new cleaning composition to be used in its printers, the submitted request may be expected to include some or all of: the specific product or process to which the request relates (e.g., chemical composition and/or method of use or disposal); the identity of the submitting company; the industry to which the request relates (e.g., printer manufacturer); the identity of the regulatory agency from which approval is being sought (e.g., the EPA); a particular legal environment; the type of compliance (e.g., chemical compliance, compliance with educational or training standards, etc.), and prior agency responses for submissions by the requestor that are considered similar (e.g., have similar combinations of factors), particularly if the request is to be a resubmission of a prior rejected request.

In one embodiment, the RCS interface 110 receives the requestor's data 14 and places it in appropriate format for the agency receiving the new request 12. In one embodiment, the RCS interface collates the data 14 and submits to each target regulatory agency only the data required by that agency (e.g., a request for a particular regulatory body to approve the inclusion of a restricted chemical in a manufactured part).

In some embodiments, the RCS interface 110 may omit requestor data from the new request 12 that is not required by the regulatory agency for a particular type of request and/or may prompt a requestor to supply additional data 14 that is determined, by the system, to have been omitted. The RCS interface 110 may determine what types of request 12 are needed for the requestor to be able to use a new composition/process and may generate two or more individualized requests 12 for submitting to different regulatory agencies, based on the same set of requestor data 14.

The database generation component 112 extracts information from the submitted requests 12, corresponding proposals 18, and corresponding agency responses 26 and stores the information in the RCS database 106. The extracted information may include information for learning/updating a prediction model(s) 126 and information to be used to formulate a new proposal 18, i.e., prior to receiving the respective response 26.

The proposal generator 114 generates a proposal 18 concerning whether the new request 12 should be approved or not. The proposal generator 114 may employ the prediction model 126, which is informed by historical data, such as prior submissions 12 and prior agency responses 26 thereto, stored in database 106.

For example, combinations of the following raw data and/or calculated values may be used by the proposal generator 114 and/or prediction model 126 as input features to its decision-making:

1. Compliance Type: The type of compliance being sought (e.g., Air Quality vs. Water Quality in the case of chemical compliance; student achievement levels in a school district in the case of educational compliance).

2. Industry Type: The industry that the request is coming from; what can be considered required/crucial for one industry may be less important in another.

3. Target Regulatory Agency/Approver. The agency that is performing the review and making the decision on the request. Previous responses 20 from the same agency may be accorded a higher weight than prior responses from other agencies within the same industry. The reviewer at the agency performing the review may also be a factor in the outcome of the review.

4. Submitting/Requesting Company. The history of a company's requests to a particular regulatory agency and the results of those requests are also factors. For example, the agency that is performing the review of a particular company's request may respond differently than it did to a similar request (using the same or substantially the same data) submitted by a different company.

5. An overall rating/prediction based on all submissions to all agencies.

6. Results from previous submissions including those made by other companies. The outcomes from all previous submissions, whether positive or negative, and regardless of other factors, can also lead to better predictions.

7. Formulated responses from the Agency/Approver. Using text parsing capabilities with keyword sensitivities, the system can identify each regulatory agency's common rejection reasons (such as “not enough detail”). This information can be used to help the submitter respond to the problem (e.g., by ensuring enough detail is provided) while also aiding in the predictive calculation of whether the submitter's answer will be accepted or not.

8. Chemical Dataset/Components. In the case of an industry making chemical regulatory compliance requests, the types and classifications of the various chemicals used in the creation of the product can change the decision of the approving body. For example, the prediction model may elevate the level of detail and scrutiny a reviewer would be expected to undertake for classes of chemicals that are considered highly dangerous in their use (unusual sensitivities to light, heat, etc.). Training the model to place these kinds of chemicals into weighted groups, can result in better predictions. While chemical compliance is used as an example here, other types of data are contemplated.

9. Data about correlations among the various raw data points. For example: past decisions on similar requests. For example, if they involve similar companies, in similar industries, made to similar regulatory bodies, decided by a reviewer with a similar track record, where the decisions in those similar situations are known, correlations among these and potentially other variables can be determined and used to improve the evaluation. The system is not limited to any particular set of such data categories.

The prediction model 126 may include a set of prediction components 128, 130, 132, 134, 136, etc., which evaluate correlations between respective features of prior requests, such as some or all of those listed above or features derived therefrom, and corresponding agency decisions 28 and optionally also their rationales 30. By combining the output from the exemplary classification models for some or all of these types of input and the data available, the proposal generator 114 can produce an overall decision 20 for acceptance or not by the particular regulatory agency and a rationale 24 for that decision.

For example, one of the prediction components 128 may perform a keyword search for hazardous chemicals and their acronyms and equivalents thereof in free text portions of the request 12. When a hazardous chemical is identified, an associated concentration of the chemical may be identified from the request, if present. If the concentration exceeds an applicable regulatory maximum, the prediction component 128 may indicate that the request should be denied. Keyword searches for other items that are likely to impact a regulatory decision may also be performed. Another prediction component 130 may predict whether required data is missing from the request. Another prediction component 132 may input a set of features extracted from the request into a classifier that has been trained on sets of features extracted from prior requests 12 and corresponding agency decisions 26. The classifier outputs a recommended decision and/or a probability for a decision. The number and types of prediction component is not limited to those illustrated.

Each of the prediction components 128, 130, 132 may output a sub-prediction for the respective prediction component. An aggregating component 134 of the model 126 aggregates the outputs of the two or more prediction components 128, 130, 132, to generate an overall prediction 138 for a decision (e.g., one of a set of two or more predefined decisions, such as approved, denied, and held) which may be in the form of a prediction that the proposed decision is correct. As will be appreciated, the generation of the overall proposed decision 20 may include placing different weights on the outputs of the prediction components 128, 130, 132, and/or in some cases, may be determined by one or more outputs of the prediction components 128, 130, 132.

For example, if one of the prediction components identifies that required data is missing, this may result in exclusion of “approved” as a possible overall proposed decision. Some or all of the prediction components may also identify a field or fields of the request 14 which contributed to the prediction and/or a basis for the prediction, such as “required data omitted from field Y1” or “concentration of component Z exceeds regulation B32.”

Example classes of decision which may be made by the prediction models 128, 130, 132, and/or 134 or proposal generator 114, based thereon may include:

1. Approved—the system proposes approval of the request (including rationale for the approval);

2. Denied—the system proposes rejection of the request (including rationale for the rejection and a description of any missing information); and

3. Undetermined—based on the available data, a proper determination could not be established. This may indicate that more information is needed or that one or more of the prediction models have not yet been sufficiently trained to respond to the current submission. The system may specify what information is missing.

The prediction 138 output by the model 134 may be in the form of a confidence (probability) in the decision that the request 12 will be approved and/or denied and/or held. The confidence measure may be a percentage, a score (e.g., from 1 to 5, with 5 being the highest), a verbal prediction selected from one of a set of possible verbal predictions or the like. For example, probabilities for predictions that are at or above a predetermined threshold may be categorized as “high probability of being approved”, while those below the threshold may be categorized as “lower probability of being approved,” and those simply missing data but not otherwise rejected may be classed as “held.” Alternatively, a more fine-grained confidence categorization may be generated, such as “strong probability of approval,” “moderate probability of approval,” “low probability of approval,” “undecided,” or the like, based on the prediction output by the model. To determine the confidence measure 22, the system may assign weights to the outputs of the various predictive classification models 128, 130, 132, etc., e.g., based on their accuracy in predicting the correctness of the prediction in actual practice (e.g., based on how often a human reviewer changes the proposed decision). In one embodiment, the confidence measure 22 may correspond to the prediction 138 output by the prediction model.

The prediction component 136 may be configured for predicting a rationale 24 for the proposed decision 20. This may include identifying one or more of the most probable prior rationales from the historical data stored in the database 106, e.g., rationales that are associated with similar features in the request data 14 and similar actual decisions 28. The prediction component 136 may receive inputs from one or more of prediction components 128, 130, 132, 134.

Examples of proposed rationales 24 may include:
the request is missing certain required data.
the request does not comply with regulatory standards, e.g., a (new) regulation applying to a component of the request is not met.
the company has a history of submitting improper requests to the same or other agencies (e.g., falsified information, irrelevant or inaccurate supporting data/references, and the like).
the agency approval/rejection rate for:
   this particular regulatory agency,
   this particular compliance type,
   this particular industry,
   this particular company (if available) and/or similar companies, and
   the same or similar data for the subject of the request.
current prediction accuracy;
specific rationale(s) for rejected submissions;
specific rationale(s) for held submissions;
and the like.

The prediction components 128, 130, 132, 134, 136 may be updated, as needed and/or periodically, based on updates to the database 106. For example, newly-added historical data extracted from the request 12, and response 26 may be used to retrain/update the prediction model(s). In some embodiments, older historical data may be discarded from the database 106 and its impact on the models thereby removed or reduced. New regulations promulgated by the regulatory agency may be incorporated into the prediction model(s). Expired regulations may be removed from the prediction model.

The proposal generator 114 receives the prediction(s) 138 output by the prediction model 126, which may include a first prediction for one or more of a set of candidate decisions which can be made by the regulatory body and a second prediction for one or more candidate rationales for the candidate decision, and generates a proposal 18 based thereon.

The evaluation performed by the system 10, can be fairly granular. In one embodiment, the proposal generator 114 determines whether to approve or deny a company's request and, if denied, identifies what additional data is required in order to receive approval. The data used to make this decision may include information about some or all of: the particular requesting company; the particular regulatory agency; a particular employee of a regulatory agency who is deciding the particular request; the particular legal environment in which the decision is being made; the type of compliance (e.g., chemical compliance); and the data set submitted in the request.

The evaluation also makes use of the historical data sets already acquired, such as: the history of the current request, if it is a resubmission; the decision history for other similar requests (e.g., made by the same or similar companies, evaluated by the same or different regulatory agencies, evaluated by the same or different individual reviewers, etc.)

In an exemplary embodiment, the proposal generator 114 formulates the proposal 18, including the proposed decision 20, estimate of the decision being correct 22, and proposed rationale 24 for the decision 20, based on the outputs of the prediction model(s) 126, and optionally also based on information extracted directly from the database 106, such as regulations, prior rationales, and the like.

The submission component 116 outputs the proposal 18 for the current request 12. In one embodiment, this may include notifying a particular employee of a particular regulatory agency that a proposal 18 for a particular request 12 is ready for inspection, which includes the proposed decision 20 and the rationale 24 for the proposed decision, in human readable form, e.g., as a set of sentences, a list, a table, a combination thereof or the like. The proposal 18 enables an authorized human reviewer to search or query the decision tree to understand why the system made the decision. The data on which the decision is based may be stored in memory for ongoing analysis. After the human reviewer makes the final decision on the request (agreeing or disagreeing with the systems proposal) that information is also sent to the system for storage and analysis.

In one embodiment, the submission component 116 outputs the proposal 18 and related request 12 to the regulatory body for review by a reviewer. The rationale 24 in the proposal 18 may identify what information is missing, if the recommendation 20 is for holding the request 12. The rationale 24 may identify bases for rejection, particularly if the recommendation is for rejecting the request. The proposal 18 may include or link to relevant historical results extracted from the database 106, to supplement the rationale 24. The relevant historical results may include some or all of: prior agency decisions 28, predicted decisions 20, agency rationales 30, and proposed rationales 24 for previous, similar submissions 12.

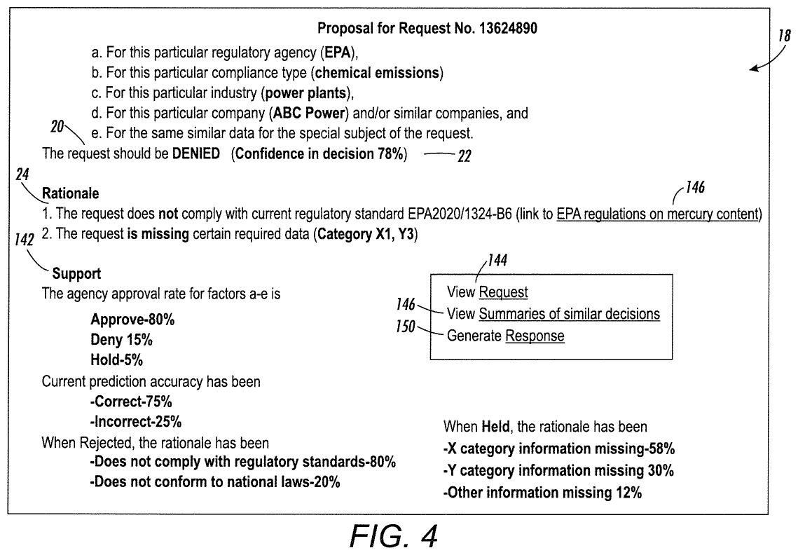

FIG. 4 illustrates an example proposal 18, which may be generated using a proposal template 140 stored in memory 40, so that the reviewer can readily identify the relevant components of the proposal. The illustrated proposal 18 includes an overall decision recommendation 20, in human-readable format, in this case, that the request should be denied. In addition to the proposed decision 20, a confidence score 22 is assigned showing how confident the system 10 is in the proposed decision 20 that it has made. High confidence decisions may lend themselves to decision-making without human intervention or with a minimal review.

A rationale 24 for the recommended decision is provided in human-readable form. In this case, the rationale indicates that the recommendation 18 has two primary factors which contributed to the decision 20. Support 142 for the rationale is provided in terms of an analysis of the relevant historical data. The proposal 18 may be configured for display in the GUI 74 on a display device for the regulator's user interface 54, e.g., with a menu, scroll down features, actuatable links, and the like. In one embodiment, the GUI 74 may display only a portion of the proposal 18 initially, with links, such as user-actuatable hyperlinks, to various parts of the proposal 18 that are not initially displayed. This allows the reviewer to see an overview of the key issues, if any, and then select relevant parts of the proposal to review in further detail.

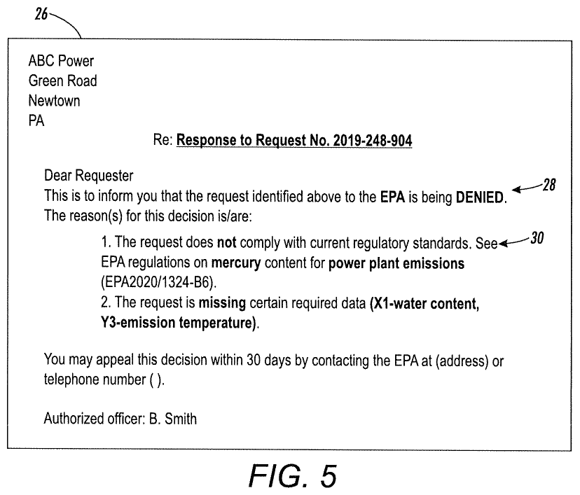

User-actuatable links 144, 146, 148, may be provided to other documents, such as the request 12 and documents supporting the rationale. Another actuatable link 150 may be provided to access a template 152 (FIG. 5) for generating the response 26. The template 152 may be automatically prefilled, for the reviewer, with information from the proposal 18 which is permitted to be shared with requestors, such as the agency's decision 28 and at least one corresponding rationale 30 for that decision (assuming that they are approved by the reviewer).

As will be appreciated, the rationale 30 may differ from the rationale 24 in that it is intended to assist the submitter, rather than the reviewer. The rationale 30 does not include information that is proprietary to other organizations, whereas the rationale 24 may do so. It also does not include the information 142 provided in support of the rationale 24 that the regulatory agency would not want released to requestors, such as that the requestor has frequently submitted falsified data, or the success rates of various types or features of requests.

The response reception component 120 receives the agency response 26 into memory 30 and matches it to the request 12 and the system's proposal 18. The response reception component 120 extracts information, including the agency decision 28 and rationale 30, from the response 26, which, together with the information extracted from the request 12 and proposal 18, is stored as historical data in the database 106. In particular, the reviewer's agreement or disagreement with the proposal 18 are stored in the database 106 to be subsequently used to improve future decision-making by the system. The response reception component 120 may also provide the response 26 to the RCS interface 110 for transmission to the original requestor or requestors.

The prediction model generation component 118 uses machine learning and/or other techniques to learn the prediction model 126 (and/or its subcomponents 128, 130, 132, 134, 136). Data for learning the model 126 may include some or all of the following: historical data contained in and/or inferred from prior submitted requests 12, proposals 18 associated with the prior submitted requests 12, and agency responses 26 to the prior submitted requests, including decisions 28 made and rationales 30 for those decisions, if any. The prediction model generation component 118 may also use data from other sources, such as agency regulations for the use of certain chemicals, amounts considered to be safe in specific products, chemicals whose use has been banned, other elements as needed, and the like.

In the case of prediction component 128, the keywords to be searched and corresponding regulated parameters (e.g., maximum or minimum concentrations of chemicals), may be identified manually or semi-automatically, from the relevant regulations. In one embodiment, a resource, such as an ontology, lexicon, or on-line resource (e.g., Wikipedia) is used to identify terms with similar meanings to the terms used in the regulations and thus expand the keywords to be searched. Rules may then be generated for identifying the regulated parameters which are related to identified keywords. Such rules may be based on a simple co-location of keyword terms (e.g., within a predetermined number of words), or may use natural language processing to identify the relationships. Where the parameters are required to be located in specific fields of the request 12, they may be identified from the appropriate fields. In some cases, one prediction component 126, 128, 130 may use information from one or more of the other prediction components to make its prediction.

In the case of prediction component 130, the component may be trained to analyze specific data fields or other parts of the request for specific data types that are required to be included.

In the case of prediction component 132, a machine learning technique, such as one or more of deep (convolutional) neural networks, linear regression, Naïve Bayes, support vector machines, random forests, decision trees, or the like may be used to learn a probabilistic model that takes as input a multidimensional set (e.g., a vector or a matrix) of features (such as at least 5, or at least 10, or at least 20, or at least 100 features, or up to 1000 or more features), and outputs a probability for a decision or over a set of possible decisions. The probabilistic model is trained on multidimensional sets (of the same dimensionality) of features extracted from the historical data extracted from the requests 12, proposals 18, and corresponding agency responses 26.

The accuracy of the overall prediction model 126 generally improves over time as the response reception component 120 receives more agency decisions. The exemplary model generation component 116 analyzes and correlates the historical data on an ongoing basis. In one embodiment, the analyses include correlation and other various machine learning techniques. Accordingly, as more data is collected (including data from the requesting companies and decisions from the reviewers), the accuracy of the proposed decision 20 and rationale 24 improves.

One or more of the prediction model(s) 128, 130, 132, 134, 136 may include machine learning classification algorithms which operate as high-volume correlation engines. As a machine learning engine takes in new data, it updates the value of each data element in determining a particular result. Different and/or additional algorithms (and/or criteria) may be used and the system may be updated to incorporate new models to improve predictive capabilities over time.

The system 10 monitors the correctness of each proposed decision 20, by comparing it to the decision made by the reviewer, with the goal of improving the accuracy of both the decision and the confidence in the decision for future requests. In general, the prediction accuracy improves over time. Initially, however, when little data has been acquired, adjusting the prediction models to account for new reviewers' decisions may result in the model predictions being less accurate, in some cases. In some cases, the accuracy of a model may peak then start to decline. For example, positive and negative feedback loops may have detrimental effects on the effectiveness of the models. Monitoring each prediction model's results can prevent these declines from becoming a problem by alerting a system administrator that a model may benefit from a modification to the classification techniques being used.

For example, an administrator or group of reviewers may perform a manual review of documents submitted in compliance requests 12 and determine that a feedback loop has caused changes or disagreements in reviewers' decisions which are undesirable. For example, a feedback loop may have caused one group of reviewers to reject requests more often than another group. In such cases, the prediction models could be modified to address the problem of a lack in agreement between groups. As an example, an administrator could determine that when the “Chemical Composition” field of a compliance request form includes the chemical “mercury” at greater than 0.1% of the total formulation, Region 5 of a particular state Department of Environmental Conservation rejects the request 30% of the time, Region 2 of the same state's Department of Environmental Conservation rejects the request 60% of the time, while Region K of another state's Department of Environmental Conservation rejects the request 80% of the time. The administrator may decide to adjust the model to provide closer agreement between reviewers in regions 5 and 2, since they are in the same state, while making no or fewer adjustments for the other state. Alternatively, or additionally, in the rationale 24 given in future proposals 18, reviewers in regions 5 and 2 may be alerted to the current disparity between regions.

In general, however, machine learning techniques enable the decision proposal process to be fully automated and enable consideration of a large number of variables over large numbers of actual agency decisions 26 and can discover and give different weights to each of the different data features, based on those actual results. As a result, little or no human intervention in the learning of the prediction models may be needed. In addition, the machine learning engines of the prediction model generation component 118 can evaluate the accuracy of its own previous predictions and include that as additional data to improve its future predictions.

In one embodiment, the reviewer may use the system 10 to perform queries of the database 106 and/or to use the proposal generator 114. For example, an agency query 160 is received by the system 10, which may include one or more features of a candidate request. The querying component 124 of the system receives the query 160 and outputs a response 162 to the query, based on a review of database 106 and/or the output of the proposal generator 114. This may be useful, for example, for reviewers wishing to test the model, or to provide guidance to sets of reviewers. It may also be useful, if the reviewer has taken some time to formulate a response 26, since requesting/receiving the original proposal 18, and suspects or knows that the proposal 18 originally received may be out of date.

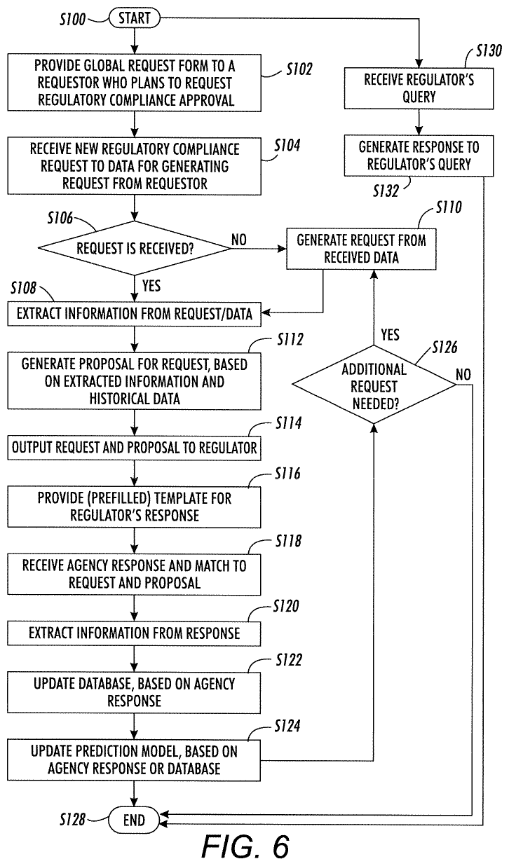

With reference to FIG. 6, a method of evaluation of a regulatory compliance request for assisting a reviewer in making a decision on the request is illustrated. The method begins at S100.

At S102, a global request form 16 may be provided to a requestor who plans to request regulatory compliance approval, e.g., by the global form generator 114.

At S104, a new regulatory compliance request 12, or data 14 for generating such a request (such as a completed global request form 16), is received from a requestor by the regulatory compliance system interface 110 and stored in memory 40, within the system or accessible to the system 10.

If at S106, the system 10 receives a request 12, the method may proceed directly to S108. Otherwise, if at S106, the system 10 receives only data 14 for generating a request 12, the method may proceed to S110, where a request 12 may be generated, based on the received data 14, by the submission component 116. The method then proceeds to S108.

At S108, information to be used in generating a proposal 18 for the request is extracted from the request 12 or data 14 and stored in memory 40, e.g., in database 106.

At S112, when a regulatory approval decision is required, an evaluation is performed, based on the new request 12, by the proposal generator 114, to generate a proposal 18, including a proposed decision 20 on the new request, a measure of confidence 22 in the proposed decision, and a rationale 24 for the decision. The evaluation may include accessing the database 106 to retrieve relevant information, such as the information extracted from the request 12/data 14 and optionally relevant historical data (for similar requests, including prior requests 12, which are not limited to those made by the same company as for the current request, respective proposals 18, and agency decisions 26 for the prior requests). The evaluation may further include accessing the prediction model 126 to provide a prediction 22 for a proposed decision 20 and corresponding rationale 24 for the decision, for the current request 12, e.g., based on the retrieved information. This may include predicting a decision by inputting features extracted from the database for the new request 12 and/or received data 14 into one or more of the prediction models.

At S114, the request 12 and related proposal 18 are output from the system 10, by the submission component 120, e.g., to a regulatory agency for making an agency decision on the request. The submission component 120 may incorporate the proposed decision 20 on the new request, the confidence measure 22, and the rationale 24 for the decision into a proposal template 138, which may be auto-filled with other information relating to the request, such as an ID for the request, requestor information, or the like, in the event that the request 12 and the proposal 18 become separated. Alternatively, the proposal 18 may be incorporated into the submitted request 12, e.g., as an attachment.

At S116, a template 152 for the regulator's response may be prefilled with information from the request and proposal and provided to the regulatory agency. A reviewer, after receiving and reviewing the request 12, related proposal 18, and the template response 152, may modify the template response 152 to generate the agency response 26, accept the template response 152 as the agency response 26, or otherwise generate the agency response 26. The agency response 26 may be sent to the requestor directly or via the system 10.

At S118, the agency response 26 (which has been generated by the human reviewer or automatically), which includes the agency's decision 28 on the request and generally a rationale 30 for that decision, is received by the reception component 120 and matched to the corresponding request 12 and proposal 18. The received agency response 26 may be sent to the requestor, if it has not been sent directly to the requestor by the agency.

At S120, the response 26 is matched to the request 12, proposal 18, and information is extracted from the response, by the extraction component 112. At S122, the extracted information is entered into the database 106, by the extraction component 112.

At S124, the prediction model 126 is provided/updated, based on the updates made to the database at S122. The prediction model 126, or parts thereof, may be updated each time an agency response 26 is received, or periodically, such as once a day, once a week, or after a preset number of agency responses 26 have been received, or when a new proposal 18 is to be generated, or at other suitable intervals.

If at S126, the requestor requests that a different request be generated and submitted from the same received data 14, e.g., to a different agency, the method may return to S110, contemporaneously or subsequently, for generating the second or a subsequent request. Otherwise the method may proceed to S128.

At S130, at any time, a reviewer may input a query 160 into the system, e.g., for querying the database 106 and/or prediction model 126. The querying component 124 receives the query and generates a query response 162, for example by calling on the proposal generator 114 to use the model 126 to generate a proposal for the agency query.

At S132, the response 162 is output from the system 10, and may be received by the requesting reviewer.

The method may return to S102 or S104 to receive a new regulatory compliance request or data for generating request from the same requestor or from a different requestor. For example, a vendor 76 may wait for its sub-vendors 70, 72, 74 to receive agency approval(s) for their submitted requests before submitting its own request.

The method ends at S128.

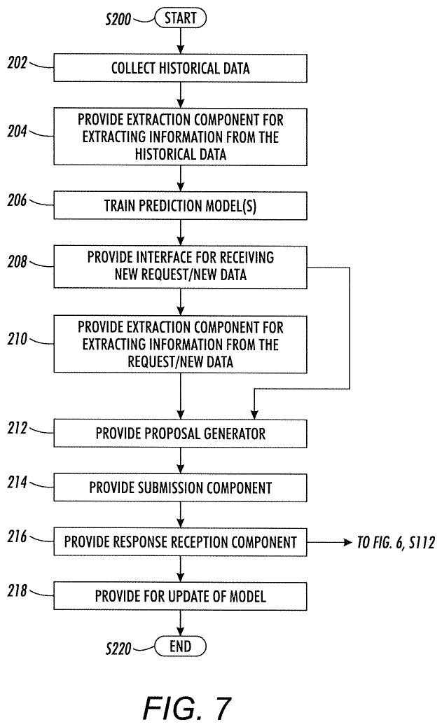

With reference to FIG. 7, a method for generating a system 10 for evaluation of a regulatory compliance request is illustrated. The method begins at S200.

At S202, historical data is collected. The historical data may be as described above, including, for example, prior requests 12 from multiple organizations, and prior responses 26 to those requests, which may include responses received from multiple regulatory bodies. Initially, there may be no proposals 18, associated with the requests, but over time, proposals 18 from the model 126 may be incorporated in the historical data. For example, historical data for at least 20, or at least 100, or at least 1000, or at least 10,000 requests may be used to generate one or more of the prediction models.

At S204, an extraction component 112 is provided, e.g., configured from software and/or hardware, for extracting information from the historical data and optionally storing the extracted information in the database 106.

At S206, a prediction model generation component 118 is provided, e.g., configured from software and/or hardware, for training the prediction model 126 to output a prediction for a new request for regulatory compliance approval, such as a prediction for a decision on the request and/or a rationale for the decision. The training is based on the historical data and/or information extracted therefrom at S204.

At S208 an interface 110 is provided, e.g., configured from software and/or hardware, for receiving a new request for regulatory compliance approval or new data for generating the new request from a requesting organization. The requesting organization may be one of the requesting organizations contributing to the historical data or a different organization.

At S210, an extraction component, which may be the same as extraction component 112 may be provided, e.g., configured from software and/or hardware, for extracting information from the new request and/or new data data and optionally storing the extracted information in the database 106.

At S212, a proposal generator 114, with access to the trained prediction model 126, is provided. The proposal generator is configured, e.g., from software and/or hardware, for generating a proposal 18 for the new request, based on the information extracted from the new request and/or new data. The proposal is also based on a prediction 138 output by the trained prediction model.

At S214 a submission component 116 is provided, e.g., configured from software and/or hardware, to provide a regulatory body that reviews the new request with access to the proposal for the new request. The regulatory body may be one of the regulatory bodies contributing to the historical data or a different regulatory body.

At S216, a response reception component 118 is provided, e.g., is configured from software and/or hardware, to receive a response 26, output by the regulatory body, to the new request. The method may then proceed to S112 of the method of FIG. 6.

At S218, provision is made for updating the trained prediction model 126, based on the information extracted from the received response, new request, and new proposal, e.g., by the prediction model generation component 118 (corresponding to S124). This may include a complete retraining of the model, retraining/updating parts of the model, or the like.

The method ends at S220.

The method illustrated in FIG. 6 and/or 7 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer system 10 (for example, an internal hard drive of RAM), or may be separate (for example, an external hard drive operatively connected with the computer system 10), or may be separate and accessed via a digital data network such as a local area network (LAN) or the Internet (for example, as a redundant array of inexpensive or independent disks (RAID) or other network server storage that is indirectly accessed by the computer 10, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphics card CPU (GPU), or PAL, or the like. In general, any device, capable of implementing a finite state machine that is in turn capable of implementing the flowchart shown in FIG. 6 and/or 7, can be used to implement the method. As will be appreciated, while the steps of the method may all be computer implemented, in some embodiments one or more of the steps may be at least partially performed manually. As will also be appreciated, the steps of the method need not all proceed in the order illustrated and fewer, more or different steps may be performed.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for evaluating a request for regulatory compliance approval comprising:
providing historical data, the historical data comprising information extracted from prior requests for regulatory compliance approval from multiple requesting organizations and information extracted from responses to the prior requests generated by at least one regulatory body;
receiving a new request for regulatory compliance approval or new data for generating the new request from a requesting organization;
extracting new information from the new request or from the new data for generating the new request;
based on the extracted new information and the historical data, generating a proposal for a response to the new request; and
providing access to the proposal to a regulatory body to which the new request is submitted for review.

2. The method of claim 1, wherein at least one of the extracting new information and generating the proposal is performed with a processor.

3. The method of claim 1, wherein the proposal includes a proposed decision on the new request.

4. The method of claim 3, wherein the proposed decision is selected from a predetermined set of at least two candidate decisions.

5. The method of claim 3, wherein the proposal for the response further includes at least one of: a proposed rationale for the proposed decision and a measure of confidence in the proposed decision.

6. The method of claim 5, wherein the proposed rationale is based on rationales extracted from the responses to the prior requests.

7. The method of claim 1, wherein the historical data includes information on at least one of:
the regulatory body responsible for the response to the each of the prior requests; and
the requesting organization for each of the prior requests.

8. The method of claim 1, wherein the proposal is generated based on the output of a prediction model that has been trained on the historical data or on information extracted therefrom.

9. The method of claim 8, further comprising receiving a response, issued by the regulatory body, to the new request and updating the prediction model based on the new request, the proposal, and the response.

10. The method of claim 8, wherein the prediction model has access to a data structure which includes, for each of the prior requests, data on the product or process for which the prior request was made, a proposed decision on the request, and a decision extracted from the response to the prior request.

11. The method of claim 8, further comprising training the prediction model based on at least one of: the historical data and information extracted from the historical data.

12. The method of claim 8, further comprising, receiving a response to the new request from the regulatory body to which the new request has been submitted and updating the prediction model based on information extracted from the response.

13. The method of claim 1, wherein the information extracted from the responses to the prior requests includes a decision on each request and, for at least some of the responses, a rationale for the decision.

14. The method of claim 1, wherein the proposal includes a prediction for at least one of a set of candidate regulatory body decisions.

15. The method of claim 1, wherein the proposal is not made accessible, in its entirety, to the requesting organization.

16. The method of claim 1, further comprising generating a plurality of requests for submission to different regulatory bodies, based on the new data and, for each of the plurality of requests, generating a respective proposal.

17. A computer program product comprising a non-transitory recording medium storing instructions, which when executed on a computer, causes the computer to perform the method of claim 1.

18. A system comprising memory which stores instructions for performing the method of claim 1 and a processor, in communication with the memory, which executes the instructions.

19. A system for evaluating a request for regulatory compliance approval comprising:
an interface which receives a new request for regulatory compliance approval, or new data for generating the new request, from a requesting organization;
a prediction model which has been trained, based on historical data, to output a prediction for a new request for regulatory compliance approval, the historical data comprising information extracted from prior requests for regulatory compliance approval from multiple requesting organizations and information extracted from responses to the prior requests generated by at least one regulatory body;
a proposal generator which inputs information extracted from at least one of the new request and the new data into the trained prediction model and generates a proposal for the new request, based on an output of the prediction model;
a submission component which provides access to the proposal to a regulatory body reviewing the new request;
a prediction model generation component which receives a response to the new request, generated by the regulatory body, and updates the prediction model, based on the new request, proposal, and response; and
a processor which implements the proposal generator, submission component, and update component.

20. The system of claim 19, further comprising a data structure accessible to at least one of the proposal generator, prediction model generation component and prediction model, the data structure storing the information extracted from: the at least one of the new request and new data, the proposal, and the response to the request.

21. A method for generating a system for evaluating a request for regulatory compliance approval comprising:
collecting historical data, the historical data comprising information extracted from prior requests for regulatory compliance approval from multiple requesting organizations and information extracted from responses to the prior requests generated by at least one regulatory body;
training a prediction model to output a prediction for a new request for regulatory compliance approval, the training being based on the historical data;
providing an interface for receiving a new request for regulatory compliance approval or new data for generating the new request from a requesting organization and extracting information from the new request or from the new data;
providing a proposal generator with access to the trained prediction model, the proposal generator generating a proposal for the new request, based on the extracted information and a prediction output by the trained prediction model;
providing a submission component which provides a regulatory body that reviews the new request with access to the proposal for the new request;
providing a reception component which receives a response, generated by the regulatory body; and
providing for updating the trained prediction model, based on the received response.
